(19) United States
(12) Patent Application Publication
(10) Pub. No.: US 2014/0074272 A1
(43) Pub. Date: Mar. 13, 2014

(54) SYSTEM FOR CREATION OF THREE DIMENSIONAL PRINTING FILES

(71) Applicant: PARAMETRIC PRODUCTS INTELLECTUAL HOLDINGS, LLC, Greenville, SC (US)

(72) Inventor: David Cowden, IV, Greenville, SC (US)

(73) Assignee: PARAMETRIC PRODUCTS INTELLECTUAL HOLDINGS, LLC, Greenville, SC (US)

(21) Appl. No.: 14/026,259

(22) Filed: Sep. 13, 2013

Related U.S. Application Data
(60) Provisional application No. 61/769,841, filed on Feb. 27, 2013.
(60) Provisional application No. 61/700,540, filed on Sep. 13, 2012.

(51) Int. Cl. G06F 17/50

(52) U.S. Cl. CPC G06F 17/50
USPC 700/97

(57) ABSTRACT

A system for storing and modifying a 3D printing file for use in 3D printing comprising: a server having a non-transitory computer readable medium and a processor in electronic communications to the non-transitory computer readable medium; a set of computer readable instructions stored in the non-transitory computer readable medium that when executed by the processor causes the server to: receiving a 3D model file representing a physical shape from a first designer's computer system in communications with the server generated by a first designed using a 3D fluent development language having a set of basic selection commands and a set of workplane commands, the 3D model having dynamic parameters and static parameters, the workplane commands having 2D commands and 3D commands.

### CLAIM OF PRIORITY

This patent is a non-provisional patent application of U.S. provisional patent applications 61/769,841 filed Feb. 27, 2013 and U.S. Patent Application and 61/700,540 filed Sep. 13, 2012, both of which are incorporated by reference.

### FIELD OF THE INVENTION

This invention is directed to a system for allowing designers to design and share 3D model files and for others to use and modify these model files to generate 3D print files for 3D printing.

### BACKGROUND

In the 3D modeling space, ‘parametric’ models are those which can be manipulated through the use of certain values (parameters), which can be configured by the designer/designer. Each time the designer changes the parameters, the solid model changes in response to the new values. However, this technology is not widely available outside the specialized realm of Computer Aided Design (CAD) designers and engineers because the cost of CAD systems is very high and requires extensive training. Further, the language is challenging to understand and contrary to the desired “fluent” coding environment. Therefore, 3D printing generally requires CAD operators who are engineers with experience in the fields of design and drafting. It would be advantageous if there was a system that used fluent parametric design so that 3D printing design can be achieved with a much lower learning curve and with less need for specialized training and experience.

There have been several efforts to improve the state of the art, but none provide all the features and advantages contained in the present invention. For example, U.S. Pat. Nos. 7,127,308; 6,629,093; 7,818,148; 6,647,305; 6,397,117 and 7,860,690 and United States Patent Application Publication 2008/0234991. Further, there are available CAD systems from DriveWorks Ltd., Thingiverse LLC and GrabCAD, Ltd., but again, none of these companies provide systems with all the features and functionality of the present invention.

Therefore, it is an object of the current invention to provide for a web-based tool that allows model designers to create 3D model files representing three dimensional shapes, which are available on a website for modification, download or to be sent to a 3D printer.

It is another object of the present invention to allow subsequent designers that do not have extensive CAD experience to configure the dynamic parameters of a 3D model file, originating with a first designer.

It is another object of the present invention to provide a system that allows models to be sent directly to an online 3D printing service.

It is another object of the present invention to introduce a scripting language making it easier to construct parametric models using a fluent general purpose scripting language by allowing designers to describe objects in a more natural language.

### SUMMARY OF THE INVENTION

The above objectives are accomplished by providing a system for designing, creating and modifying a 3D printing file for use in 3D printing comprising: a server having a non-transitory computer readable medium and a processor in electronic communications with said non-transitory computer readable medium; a set of computer readable instructions stored in said non-transitory computer readable medium that when executed by said processor causes said server to perform the steps of: receiving a 3D model file representing a physical shape from a first designer's computer system in communications with said server generated by a first designer using a fluent development language having a set of basic selection commands and a set of workplane commands, said 3D model having dynamic parameters and static parameters, said workplane commands having 2D commands and 3D commands, receiving modification instructions from a second designer's computer system representing desired modifications to said 3D model file desired by a second designer using a modification graphical user interface to modify the 3D model file wherein only said dynamic parameters can be modified, receiving build instructions from said second designer's computer system instructing said server to generate a 3D print file suitable for a 3D printer from said 3D mode file, and, receiving transmission instructions from said second designer's computer system instructing said server to transmit said 3D print file to a remote computer system from that of said server, and transmitting said 3D print file to said remote computer system in response to receiving said transmission instructions.

The system can also include fluent commands selected from the set of CADQuery commands and the server can perform the steps of receiving credit instructions representing credits from said second designer's computer system prior to modifying said 3D model file according to said modification instructions, receiving credit instructions from said second designer's computer system prior to transmitting said 3D model to said remote computer system. The remote computer system is said second designer's computer system or a printing service bureau.

The fluent commands can be CQ commands or WorkPlane commands.

### DESCRIPTION OF THE DRAWINGS

The following description of the invention will be better understood by reference to the following drawings that are incorporated and made part of the written specification:

FIG. 1 is a schematic of aspects of the invention;

FIG. 2 is a schematic of aspects of the invention; and,

FIG. 3 is a schematic of components of the invention.

### DESCRIPTION OF THE INVENTION

Computer readable instructions, when executed by a computer processor, cause the computer to perform a series of steps to accomplish a specific task and results in useful, concrete and tangible results. These computer readable instructions can be tied to a particular machine or apparatus with specific purpose of executing the computer readable code for accomplishing tangible results, and represents and accomplishes the manipulation of physical data.

The detailed description that follows may be presented in terms of program procedures executed on a computer or network of computers. These procedural descriptions are representations used by those skilled in the art to most effectively convey the substance of their work to others skilled in the art. These procedures herein described are generally a self-consistent sequence of steps leading to a desired result when executed by a computer and its processor representing or resulting in the tangible manipulation of physical objects. These steps also require physical manipulations of physical quantities such as electrical or magnetic physical elements and are capable of being stored, transferred, combined, compared, or otherwise manipulated readable medium that is designed to perform a specific task or tasks. Actual computer or executable code or computer readable code may not be contained within one file or one storage medium, but may span several computers or storage mediums. The term “host” and “server” may be hardware, software, or combination of hardware and software that provides the functionality described herein.

The present invention is described below with reference to flowchart illustrations of methods, apparatus (“systems”) and computer program products according to the invention. It will be understood that each block of a flowchart illustration can be implemented by a set of computer readable instructions or code.

Elements of the flowchart support combinations of means for performing the special functions, combination of steps for performing the specified functions and program instruction means for performing the specified functions. It will be understood that each block of the flowchart illustrations can be implemented by special purpose hardware-based computer systems that perform the specified functions, steps, or combinations of special purpose hardware or computer instructions.

The present invention is now described more fully herein with reference to the drawings in which the preferred embodiment of the invention is shown. This invention may, however, be embodied in many different forms and should not be construed as limited to the embodiment set forth herein. Rather, these embodiments are provided so that this disclosure will be thorough and complete and will fully convey the scope of the invention to those skilled in the art.

Features that can be provided by this invention include: the deployment of parametric 3D design in a web environment; the ability of the designer to change the 3D model file and parameters and immediately view the resulting model; the ability of the designer to download and/or print the 3D model in a single step; the method of describing a parametric 3D object with a plain-text fluent script that can be read and shared over the internet without special software; the ability of designers to create a parametric 3D model files that can be subsequently modified by designers unfamiliar with 3D design and printing; the ability to send a configured model directly to a printing service with one step; the ability to control the quality (tessellation tolerance) of the generated model; the ability to execute 3D models such that scripts from untrusted sources reducing the likelihood of the computer executing the model to be damaged (hardware and software); the ability to build 3D model file from smaller, re-usable components; the ability to provide an online service that allows remote computers to generate 3D models and integrate them into their system; the ability to make a copy of a 3D models with a single click, for subsequent alteration; the ability to automatically save a screen image of a 3D model for display to designers searching for a model; the ability of designers to constrain and validate designer inputs so that resulting objects are valid; the method of deriving revenue from model configuration downloads; the method of deriving revenue through use by remotely connected computer systems.

Further, the designers can accomplish tasks and perform actions without the installation of any software, without knowledge of 3D design systems or concepts, without detailed knowledge of 3D printing concepts or vendors, and with a minimum of time and effort. Generally, there are five phases in the operation of the present invention: (1) designer authentication; (2) creation of a 3D model file (3) location of a target model that the designer wishes to configure; (4) customization of the model using various parameters; and (5) downloading and printing the resulting model.

In operation, the invention facilitates the following steps:

(1) Authentication. The designer loads a web browser from a URL from a server to a local computer system. In one embodiment, the URL site can authenticate designers using credentials from third party or remote websites where the designer maintains a designer accounts.

In operations, the computer readable instructions located on the server allow the designer to create an account if needed. Next, the designer can create the 3D model file (or upload a preexisting file on one embodiment). Before a second designer can select and customize a 3D model file, it should be created by an initial of first designer. The designer creates a 3D model file which can produce a number of configurations that might be suitable for subsequent or second designers. An designer begins a model using one of several options:

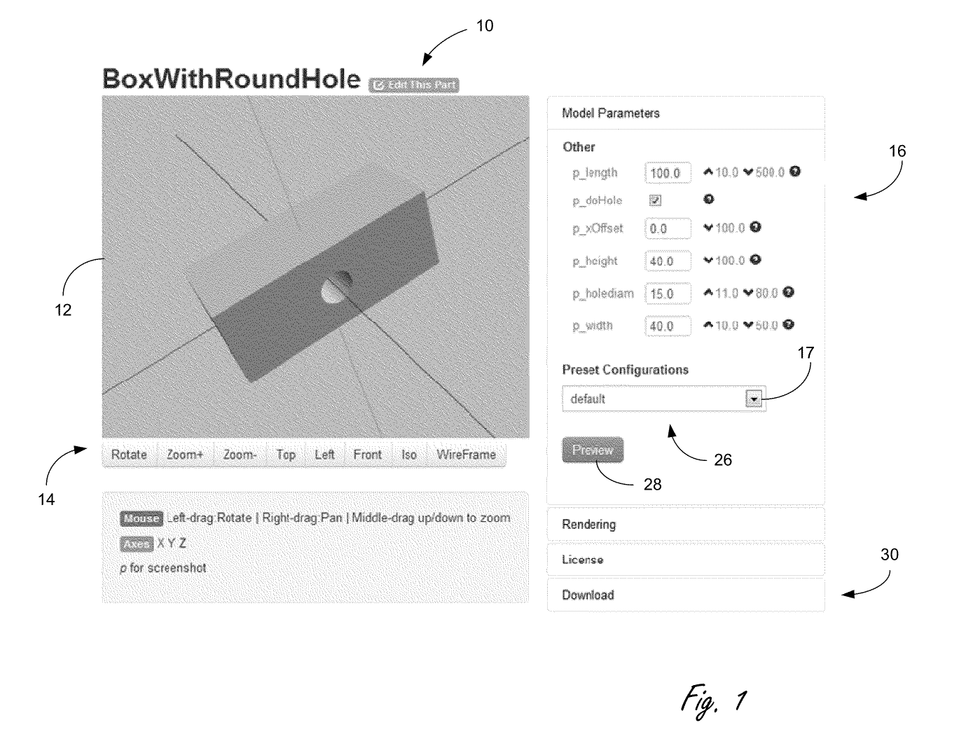

(a) Creating a new 3D model file. If the designer wishes to create a new 3D model file, the designer clicks a button, which loads a web screen in which a new model can be saved. An example is displayed in FIG. 1 where the modification graphical user interface is shown. The button 10 allows a designer to edits the selected 3D model file. The window 12 displays the model in 3D form and in one embodiment shows the three axis. Display commands 14 allow the display of the 3D model file to be manipulated with functions that include rotate, zoom in, zoom out, top view, left view, front view and a wire frame view. The parameters that are associated with the 3D model file are shown in window 16 and include parameters such as length, the inclusion of a bore, the offset of the center of the bore, height, the bore size and the width. The designer can alter these parameters if sufficient permissions have been granted by the original designer for allowing the parameters to be dynamic. The graphical modification user interface can also include functionality of rendering the 3D model file into a 3D print file, licensing information and the ability to download the 3D model file or 3D print file.

(b) Making a derivative of an existing model. If a new model should be similar to one that already exists, and the designer has the appropriate permission to create a derivative work, an existing model can be copied and used as the basis for a new model. Designer can use a single click to copy an existing model, which will create a copy, and load it for editing in a new screen. It should be noted that the ease with which this copy can be made is an important aspect of the invention, because it encourages the growth of models that are available. The specific parameters can have a default value shown as a preset 17

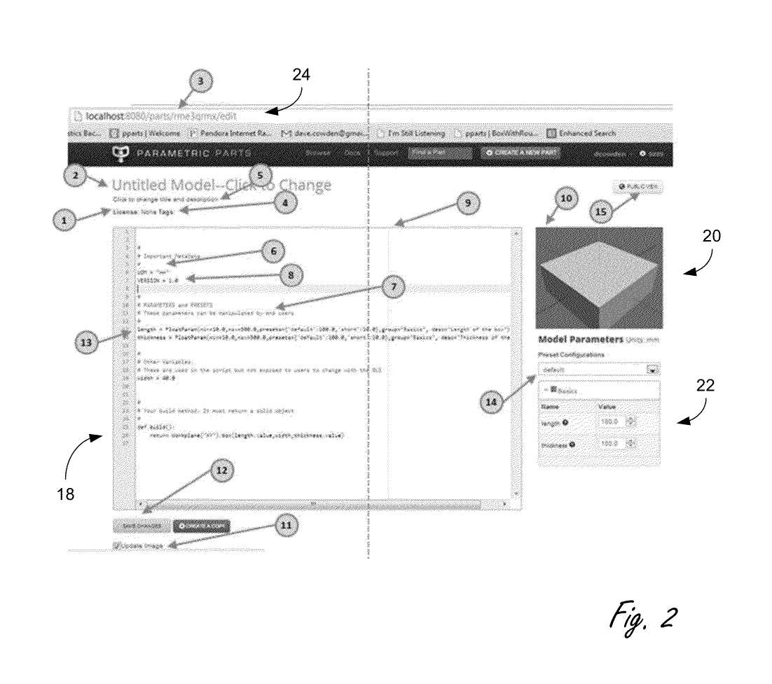

In one embodiment, a textual edit screen as shown in FIG. 2 can be used to create or modify a 3D mode file. The textual window 18 allowed the designer to change the text (such as CADQuery) using an integrated text editor. A 3D representation of the 3D mode file can be shown in window 20 and the 3D mode file parameters can be shown and modified in window 22 of this modification graphical user interface. In one embodiment, the 3D representation is automatically updated when the text changes.

Some of the options that the designer of the 3D model can select to accompany each 3D model file include:

(i) A license type selected from several available, which decides whether other designers may make derivative works; (ii) a title is provided that can aid in searching for particular 3D model files; (iii) a short URL is computed automatically, and displayed in the URL bar 24, for the purposes of allowing the designer to share the model easily with other designers via a network including a global communications network; one or more tags, which are used by designers to locate the model; a description, which conveys the intent of the object to designers; a unit of measure, which identifies the length unit of measure in which the model is computed, and which aids in printing; notes and comments, which are helpful for the designer and designers to communicate other information about the model which might be necessary; (viii) a version indicator, which indicates the type of script used in the model, for the purposes of supporting older script versions as new ones are released.

In the text editor, the designer can enters text using the editor which can highlight language keywords as the designer types. Further, real-time auto-complete functionality can be added to assist the designer in typing valid 3D model commands.

At least once and optionally after every change, an image of the generated object is saved automatically and uploaded to the server. The designer can cause the image to be updated, in combination with the save change button. Though the preferred embodiment only allows one such image, the ability to save several images may be added, so that the designer can display the model in many configurations of interest to designers.

Designer may optionally specify parameters for each model which can be customized by designers when models are generated. Parameters include but are not limited to: (i) a type, including numeric, Boolean, or choice from a list; (ii) an optional upper and lower bound, which are used to prevent designers from supplying invalid values; (iii) a name, which is displayed to the designer; (iv) help text, displayed to the designer if more information about the parameter is necessary; (v) a default value, which is used to render the model before the designer customizes any parameter values; (vi) a list of preset values, which identifies the values of the parameter that should be associated with the named preset; (vii) whether or not the specific parameter can be modified by a subsequent or second designer.

For example, the first designer may elect to for the bore in the 3D model file of FIG. 1 to remain a certain diameter and make this parameter static so that it can be not be modified by subsequent designers. Alternately, the designer can limit the modification to a range of diameters. Alternatively, the designer can decide that the bore can be completely removed. Therefore, the designer has the ability to make the model parameters dynamic so that they can be modified or static thereby preventing modifications.

In the designer desires, the 3D model file can be licensed. Therefore, the subsequent or second designer can transmit credits, monies or other consideration to the server so that the subsequent or second designer licenses the ability to view, modify, download or print the model file.

In defining presets, the designer creates a list of pre-set configurations that may be especially useful to designers. Examples might include standard hole sizes for adapter plates and many other uses. Presets appear in drop down list 26 of FIG. 1, so the designer can preview their affect.

The designer may repeat the actions to edit and save a model using button many times before it is complete. Once complete, the designer may share the URL link with other designers. Some models may be featured on the website to increase exposure to designers. This is particularly useful if the designer will derive revenue from designer downloads of the model.

(3) Model Selection Process. The designer's choice of a model indicates the general object they wish to print or download. These step can include:

(a) The designer clicks a web site link provided by another designer which links to the invention directly. In this case, the designer's URL causes the computer readable instructions of the website to locate a particular part or model, which is stored in a database of models, and to retrieve and render the selected model.

(b) The designer loads the URL and then types search criteria into a search box located on the website of the invention. The computer readable instructions on the server can then searched a set of 3D model files for matching parts and displayed a list of results from which the designer can choose a particular 3D model file. The list includes the number of matching models which can have a title and a thumbnail picture showing the object in its default configuration. In one embodiment, the designer may search using not only title and description, but also tags that may be present on the model. Other embodiments may include other fields such as number of downloads, designer, comments by other designers, create date, and many other pieces of information. All of this information would be in the spirit of the invention

(c) The designer chooses a “browse” function and reviews or pages through available models that are displayed to the designer. In one embodiment, the model can be organized by category.

(d) Once a model is located, in one embodiment, a view of the 3D model file is displayed to the designer.

(4) Customization of the Model. The designer follows steps to adjust the model to suit his needs. The model designer has provided customization points, which are displayed to the designer. The designer then interacts with the modification graphical user interface as follows:

(a) The designer is presented with a default view, which corresponds to the model customized with the default values of the configuration options (“parameters”). The default values of the parameters are displayed to the designer which also serves to allow the designer to customize the values.

(b) The designer can use zoom+, zoom−, top, left, front, and other view buttons, representing functionally of the invention to change the view to see the part better. The view can be automatically updated each time the designer presses one of the view buttons, the display is updated in real time to show a new view of the part.

(c) The designer can then drag the mouse or other screen navigation device over the part view and rotate it to see it from different perspectives.

(d) The designer changes one or more parameters and can click the “preview”’ button 28 to have the computer readable instructions render the representation of the 3D model file on the display.

(e) The designer optionally can hover the mouse or other navigation device over the tool tips on the modification graphical user interface. These tool tips can then display help, instructions or other information about what each parameter changes.

(f) The designer optionally can select a preset configuration option from the list of choices. When one of these is selected, the parameters are updated to values pre-set by the model designer. The parameter input boxes are updated as well.

(g) The designer can also expand the “Rendering” tab to show rendering options, which includes the tessellation accuracy in one embodiment. If desired, the designer can change this value and click “preview”, which renders the model with the new settings.

(h) The designer optionally selects the ‘auto apply’ box, which automatically renders the model after changes, rather than requiring the preview button to be pressed, which saves effort for the designer.

The designer can perform some or all of these steps, many multiple times, before arriving at the desired object. While simple models typically render quickly, more complex models take longer to render. Therefore there are several application features to assist the designer:

(a) The time required to render an object is stored on the server and updated each time the model is rendered. The server computes a rolling average render time, which is used to estimate how long rendering will take. In one embodiment, the average render time is displayed.

(b) When the model is created, preset configurations are known and the rendered model is computed for each known configuration. These can be cached so that designers who select a preset configuration see the resulting model very quickly.

(c) If the time required to render or build the model is larger than the time required for the designer to click or interact with the parameters (for example about 0.5 seconds), multiple designer interactions such as clicks can be ignored, to prevent wasting server resources.

(5) Printing or Downloading Models.

(a) When the designer is ready to download or print a model, the designer chooses the “Download” or “Print” section 30 to download or print the 3D print file. When printing, the process is determined according to the type of printer. For example, if the designer has a 3D printer, the designer will choose download button, and one of the options selected from “Download STL”, “Download STEP”, or “Download AMF”, as determined by the format or file used by the particular printer available. When this function is selected, the computer readable instructions at the designer's computer will download the file to the local computer and prompt the designer for a location to save the file. In one embodiment, the file that is downloaded is an approximation of the original file, in the designer's desired configuration. In one embodiment, the file that is triangulated meshes such as with STL and AMF. In another embodiment, the file is a boundar representation of the object such as STEP. In one embodiment, the file format created contains data fields supplied by the designer to aid in printing. Examples include but are not limited to the unit of measure, and the desired material. When the designer downloads the object, a database stores the object name, its designer, the date/time, and the designer who downloaded it, for the purposes of revenue generation and website analysis.

(b) If the designer wishes to print the object, the designer will select “Print” to select this functionality. In one embodiment, several choices are available linking to third party 3D printing services, for example Shapeways.com and I.Materialize. Selecting this option results in the computer readable instructions transmitting the model to the 3D printing service and redirects the designer to the remote site. The transmitted data is generally the same format or file type as that is downloaded, but it is transmitted directly to the 3D printing service vendor.

(c) After being redirected to the remote site, the designer is presented with additional information required to submit a print request at the vendor based upon the vendors requirements and system. This information may include the desired material, shipping speed, payment details, shipping address and color. The input formats may vary by vendor. Information provided by the designer may also be included in the information sent to the vendor, reducing the effort required by the designer. As an example, if the designer has indicated the unit of measure in the script, it may be sent to the vendor, preventing the designer from entering it manually. Typically, the printing service will require authentication. If the designer has an account, login is necessary. If designer does not have an account, typically one must be created. Once the designer has authenticated, the designer submits the job. After the object is printed, it is shipped to the designer. Authentication can be handled by allowing designers to use Facebook, linked in, Gmail, or other common internet services (“social authentication providers”).

Remote API

The invention also provides the ability for remote computers to create 3D content, for purposes of interest to the remote system. The process follows these general steps:

(1) Authentication. A designer is authenticated to the system as described above. Once authenticated, the designer must have permission to use API access. This may be granted by system administrators, or automatically based on successful completion of a subscription. Once API access is allowed, the designer generates an API key and token, which can be used by a remote computer system to generate 3D models.

(2) Transaction initiation. Once an API key and token are created, the remote computer system sends transactions to the URL of the invention. The transactions include the API key and token, along with instructions that will enable the invention to produce 3D models requested. The instructions include but are not limited to:

(i) a model script, in the case that the remote system wishes to store its own models in a database as opposed to storing them in the invention,

(ii) a model key, in the case that the remote system wishes to store models,

(iii) parameter names and values, selecting values of the model parameters that should be used when the model is generated,

(iv) output type, which selects the type of output that will be created. Examples include STEP, STL, and AMF.

(3) Model generation. After receiving the request, the invention will render the model and transmit the result to the remote computer as requested. The API key and token may be used to store the requesting computer, so that fees can be assessed for the exchange.

CADQuery

In one embodiment the scripting language, CADQuery, is used. CADQuery creates computer readable instructions directed to 3D model files and 3D printing that are not CAD, and do not require substantial time and experience to use. Whereas a typical language, such as FreeCAD, would require designers to write very detailed code to construct a model, CADQuery provides high-level functions to make it very easy. CADQuery is a set of instructions that are fluent and include basic selection comments and workplane commands where the workplace commands include 2D commands and 3D commands. The advantages to the CADQuery of this invention is that it creates computer readable instructions directed to 3D model files and 3D printing that are not CAD, FreeCAD command and do not require substantial time and experience and expertise to use. The CADQuery set of instructions includes the following commands (CQ commands):

| | |
|---|---|
| CQ.all( ) | Return a list of all CQ objects on the stack. |
| CQ.size( ) | Return the number of objects currently on the stack |
| CQ.vals( ) | get the values in the current list |
| CQ.add(obj) | adds an object or a list of objects to the stack |
| CQ.val( ) | Return the first value on the stack :return: the first value |
| | on the stack. |
| CQ.first( ) | Return the first item on the stack :returns: the first item |
| | on the stack. |
| CQ.item(i) | Return the ith item on the stack. |
| CQ.last( ) | Return the last item on the stack. |
| CQ.end( ) | Return the parent of this CQ element |
| CQ.vertices([selector]) | Select the vertices of objects on the stack, optionally |
| | filtering the selection. |
| CQ.faces([selector]) | Select the faces of objects on the stack, optionally |
| | filtering the selection. |
| CQ.edges([selector]) | Select the edges of objects on the stack, optionally |
| | filtering the selection. |
| CQ.wires([selector]) | Select the wires of objects on the stack, optionally |
| | filtering the selection. |
| CQ.solids([selector]) | Select the solids of objects on the stack, optionally |
| | filtering the selection. |
| CQ.shells([selector]) | Select the shells of objects on the stack, optionally |
| | filtering the selection. |
| CQ.compounds([selector]) | Select compounds on the stack, optionally filtering the |
| | selection. |
| CQ.shell(thickness) | Remove the selected faces to create a shell of the |
| | specified thickness. |
| CQ.fillet(radius) | Fillets a solid on the selected edges. |
| CQ.split([keepTop, keepBottom]) | Splits a solid on the stack into two parts, optionally |
| | keeping the separate parts. |
| CQ.rotateAboutCenter(axisEndPoint, | Rotates all items on the stack by the specified angle, |
| angleDegrees) | about the specified axis |
| CQ.translate(vec) | Returns a copy of all of the items on the stack by the |
| | specified distance |
| CQ(obj) | Provides enhanced functionality for a wrapped CAD |
| | primitive. |
| CQ.workplane([offset, invert]) | Creates a new 2-D workplane, located relative to the first |
| | face on the stack. |

The workplace command (WorkPlane) can include 2D and 3D commands. The 2D commend set can include:

| | |
|---|---|
| Workplane.center(x, y) | Shift local coordinates to the specified location. |
| Workplane.lineTo(x, y[, | Make a line from the current point to the provided point |
| forConstruction]) | |
| Workplane.line(xDist, yDist[, | Make a line from the current point to the provided point, |
| forConstruction]) | using |
| Workplane.vLine(distance[, | Make a vertical line from the current point the provided |
| forConstruction]) | distance |
| Workplane.vLineTo(yCoord[, | Make a vertcial line from the current point to the provided |
| forConstruction]) | y coordinate. |
| Workplane.hLine(distance[, | Make a horizontal line from the current point the |
| forConstruction]) | provided distance |
| Workplane.moveTo([x, y]) | Move to the specified point, without drawing. |
| Workplane.move([xDist, yDist]) | Move the specified distance from the current point, |
| | without drawing. |
| Workplane.spline(listOfXYTuple[, | Create a spline interpolated through the provided points. |
| . . . ]) | |
| Workplane.threePointArc(point1, | Draw an arc from the current point, through point 1, and |
| point2[, ...]) | ending at point 2 |
| Workplane.rotateAndCopy(matrix) | Makes a copy of all edges on the stack, rotates them |
| | according to the provided matrix, and then attempts to |
| | consolidate them into a single wire. |
| Workplane.mirrorY( ) | Mirror entities around the y axis of the workplane plane. |
| Workplane.mirrorX( ) | Mirror entities around the x axis of the workplane plane. |
| Workplane.wire([forConstruction]) | Returns a CQ object with all pending edges connected |
| | into a wire. |
| Workplane.rect(xLen, yLen[, | Make a rectangle for each item on the stack. |
| centered, . . . ]) | |
| Workplane.circle(radius[, | Make a circle for each item on the stack. |
| forConstruction]) | |
| Workplane.polyline(listOfXYTuple[, | Create a polyline from a list of points |
| . . . ]) | |
| Workplane.close( ) | End 2-d construction, and attempt to build a closed wire. |
| Workplane.rarray(xSpacing, | Creates an array of points and pushes them onto the |
| ySpacing, xCount, . . . ) | stack. |

The 3D commands can include the following:

| | |
|---|---|
| Workplane.cboreHole(diameter, | Makes a counterbored hole for each item on the stack. |
| cboreDiameter, . . .) | |
| Workplane.cskHole(diameter, | Makes a countersunk hole for each item on the stack. |
| cskDiameter, . . .) | |
| Workplane.hole(diameter[, depth]) | Makes a hole for each item on the stack. |
| Workplane.extrude(distance[, | Use all un-extruded wires in the parent chain to create a |
| combine]) | prismatic solid. |
| Workplane.cut(toCut[, combine]) | Cuts the provided solid from the current solid, IE, |
| | perform a solid subtraction |
| Workplane.cutBlind(distanceToCut) | Use all un-extruded wires in the parent chain to create a |
| | prismatic cut from existing solid. |
| Workplane.cutThruAll([positive]) | Use all un-extruded wires in the parent chain to create a |
| | prismatic cut from existing solid. |
| Workplane.box(length, width, height[, | Return a 3d box with specified dimensions for each |
| . . . ]) | object on the stack. |
| Workplane.union([toUnion, combine]) | Unions all of the items on the stack of toUnion with the |
| | current solid. |
| Workplane.combine( ) | Attempts to combine all of the items on the items on the |
| | stack into a single item. |

This fluent development languages offers many advantages over the prior art. For example, the high level, time-saving functions CADQuery can include: (a) select edges, faces, and points of a model with only one line of code, instead of many; (b) allow ‘sketching’ in 2 dimensions on an existing solid face, saving the designer from doing everything in 3D space; (c) provide easy-to-use constructs to create common shapes with less effort.

CADQuery is significantly easier to use than non-fluent languages of the prior art, reducing both code complexity and length. For example, a non-fluent alternative command set that produces the bottle is approximately 50 lines, and requires quite a bit of redundant and difficult code as shown in Table 1.

TABLE 1
aPnt1=Base.Vector(-p_width.value/2.,0,0)

aPnt2=Base.Vector(-p_width.value/2.,-p_thickness.value/4.,0)
aPnt3=Base.Vector(0,-p_thickness.value/2.,0)
aPnt4=Base.Vector(p_width.value/2.,-p_thickness.value/4.,0)
aPnt5=Base.Vector(p_width.value/2.,0,0)
aArcOfCircle = Part.Arc(aPnt2,aPnt3,aPnt4)
aSegment1=Part.Line(aPnt1,aPnt2)
aSegment2=Part.Line(aPnt4,aPnt5)
aEdge1=aSegment1.toShape( )
aEdge2=aArcOfCircle.toShape( )
aEdge3=aSegment2.toShape( )
aWire=Part.Wire([aEdge1,aEdge2,aEdge3])
aTrsf=Base.Matrix( )
aTrsf.rotateZ(math.pi) # rotate around the z-axis
aMirroredWire=aWire.transformGeometry(aTrsf)
myWireProfile=Part.Wire([aWire,aMirroredWire])
myFaceProfile=Part.Face(myWireProfile)
aPrismVec=Base.Vector(0,0,p_height.value)
myBody=myFaceProfile.extrude(aPrismVec)
myBody=myBody.makeFillet(p_thickness.value/12.0,myBody.Edges)
neckLocation=Base.Vector(0,0,p_height.value)
neckNormal=Base.Vector(0,0,1)
myNeckRadius = p_thickness.value / 4.
myNeckHeight = p_height.value / 10
myNeck = Part.makeCylinder(myNeckRadius,myNeckHeight,neckLocation,neckNormal)
myBody = myBody.fuse(myNeck)
faceToRemove = 0
zMax = −1.0
for xp in myBody.Faces:

try:

surf = xp.Surface
if type(surf) == Part.Plane:

z = surf.Position.z
if z > zMax:

zMax = z
faceToRemove = xp

except:

continue

myBody = myBody.makeThickness([faceToRemove],-p_thickness.value/50 , 1.e−3)
return myBody

Contrast this with the CADQuery version, which is much shorter and is much easier to create as shown in Table 2.

TABLE 2
(L,w,t) = (20.0,6.0,3.0)
s = Workplane(“XY”)
#draw half the profile of the bottle and extrude it
p = s.center(-L/2.0,0).vLine(w/2.0) \

.threePointArc((L/2.0, w/2.0 + t),(L,w/2.0)).vLine(-w/2.0) \
.mirrorX( ).extrude(30.0,True)

p.faces(“>Z”).workplane( ).circle(3.0).extrude(2.0,True) #make the neck
result = p.faces(“>Z”).shell(0.3) #make the shell

A number of features make this script both more intuitive and brief:

(a) faces (“+Z”) allows selecting faces that are oriented in the Z direction, rather than writing a loop and computing this by hand,

(b) Workplane( ) allows selecting a face, and then operating in the 2-d coordinate system of the face, allowing geometry to be expressed in 2-d coordinates. These 2d coordinates are automatically expanded to 3D,

(c) A fluent API reduces redundant typing of intermediate variable names,

(d) Positions use simple tuples instead of the longer Base.Vector notation,

(e) Abstract constructs such as faces and wires are removed, so that only those necessary remain,

(f) Complex constructs like rotation matrices are replaced with simple and intuitive functions like mirror( ). Together, these functions dramatically reduce the time and expertise required to develop a model.

The invention can define a large number of CADQuery functions that reduce the effort required to construct objects. Examples in one embodiment include: 2D line creation; 2D work plane creation; functions to move and rotate objects in 2D space; 2D mirroring; 2D splines curves; 2D arcs; joining multiple 2D geometries together; 2D rectangles; 2D circles; 2D polylines; 2D triangles; 3D primitives, including boxes, cones, wedges, cones, spheres, and plates; 3D constructive solid geometry operations, including cut, cutThruAll, union, intersection; 2D to 3D operations including extrusion, sweeping, revolution; 3D splitting; 3D shelling; 3D filleting; 3D transformations much as rotating and translating; 3D plugins such as countersunk holes, counter-bored holes, and simple holes. Other features may be added over time to further reduce the effort required to create objects, but these additions would all be in the spirit of the invention. CADQuery makes it possible to create very complex objects with very brief scripts that has not previously been known.

Feature Selection

When constructing a 3D object, it is often necessary to locate one or more features relative to others. Doing so reduces the effort required to create an object, and reduces the redundant information required to define the model.

The current invention provides feature selection through the use of a fluent API, combined with program instructions that approximate the selection process used when a designer interacts with a rendering of a model and pointing device. Selectors can be used to select faces, edges, solids, wires, and vertices, and/or center points on those features. Once selected, these features can be used to define other geometry without manually computing or repeating those locations. In one embodiment, selectors available included but were not limited to: nearest to point; parallel to direction; perpendicular to direction; type (such as vertex, face, solid, wire); direction; furthest in direction.

In one embodiment, a compact and easy to use syntax allows applying selectors with a minimum amount of effort as shown in Table 3. Other methods may include proximity to points or lines, visibility, angles, center points, end points, mid points, tangent points, centers of mass, area, volume, length, feature type, creation order, and absolute position. Those experienced in the art will recognize that there are a wide variety of approaches to programmatically select object features, and that all of these methods would be in the spirit of this invention.

TABLE 3

result = Workplane(“front”).box(2.0,2.0,0.5)
result.faces(“>Z”) #select the face of box farthest in the Z direction
result.vertices( ) # select the vertices of the box
result.faces( )[0] #select the first face of the box
result.edges(“|Z”) # select edges oriented parallel to the Z axis
result.edges(“#Y”) #select edges perpendicular to the Y axis
result.faces(“%Plane”) #selects faces that are planes

Once features are selected, the invention makes it easy to apply operations to all of the selected features without writing a loop construct by hand. This reduces the effort to create the model, and improves the readability of the model script. For example, Table 4 shows a line of CADQuery code that will fillet selected edges on the selected cube:

TABLE 4

cube = Workplane(“front”).box(2.0,2.0,2.0)
cube.edges( ).fillet( )

Those experienced in the art will recognize that many combinations of functions are possible using this combination of functions and selectors. Further, there are many other functions and selectors that could be possible, and these would be in the spirit of this invention.

Plugins

Though many simple models can be created using a single script, in practice complex models typically benefit from the re-use of blocks of code that are already available. This is especially true in the preferred embodiment, because the use of a general purpose language (Python) makes it much more likely that such code is available. The current invention provides a mechanism to load local or remote blocks of code (“plugins”) into a script, for the purpose of re-using them among many models. The process works as follows:

(1) A plugin that is suitable for re-use is created. This code may be a simple function, for example code that automatically creates the outline of a gear tooth profile (known by those skilled in the art as an involute), or it may create a complete 3D object, such as a bolt or a letter. Plugins may be added directly into the CADQUERY language, in such a way that they can be used with a minimum of effort. In the preferred embodiment, many functions such as cbore( ) and hole( ) are implemented as plugins. Table 5 illustrates a typical plugin:

TABLE 5

def rPoly(self,nSides,diameter):

def_makePolygon(center):

#pnt is a vector in local coordinates
angle = 2.0 *math.pi / nSides
pnts = [ ]
for i in range(nSides+1):

pnts.append( center + Vector((diameter / 2.0 * math.cos(angle*i)),(diameter / 2.0 *

math.sin(angle*i)),0))

return Wire.makePolygon(pnts)

return self.eachpoint(_makePolygon,True)

Workplane.rPoly = rPoly
s =

Workplane(“XY”).box(4.0,4.0,0.25).faces(“>Z”).workplane( ).rect(2.0,2.0,forConstruction=True).vertices( )\

.rPoly(5,0.5).cutThruAll( )

(2) The plugin is stored on a server. Two storage mechanisms are available:

(a) The plugin may be stored on the server of the invention, with the permission of the administrators. This is best when the plugin is very commonly used, because it allows models to build more quickly, but it is more effort for the designer and administrators of the invention.

(b) The plugin may be stored on any remote HTTP server. This does not require the involvement of administrators of the invention, and is often easier for the designer. It also provides the designer with the ability to restrict access to the plugins if desired. It should be noted that the ability to integrate plugins from remote servers is a key feature of the invention, because it allows 3D models to be constructed by assembling many plugins together, even when the models are stored on one or more remote computers connected by the internet.

(3) The plugin is referenced from within one or more models. In most cases, multiple models will use the same plugin, perhaps many times. Plugins are loaded by using a special syntax made available by the CADQuery script. Table 6 illustrates an example of the use of a plugin inside of a script:

TABLE 6
plugin.loadScript(http://www.someremotesite.com/cq/makeGearTooth.py)
object =
plugin.loadObject(http://www.someremotesit.com/objects/gnome.step)

In this example, a remote site called www.someremotesite.com hosts a plugin named “makeGearTooth.py”, and a STEP object called “gnome.step”

(4) The plugin is executed. When the script is executed, the computer instructions of the invention fetch the remote plugin, and execute its contents. In the case of the plugin, the script may define functions, variables, and CADQuery functions. In the case of a remote object, the object can be a STEP, STL, IGS, or other cad object. In one embodiment, a cache is maintained in the memory of the invention to prevent fetching the same plugins too many times.

Referring to Table 5, those experienced in the art will recognize the value in the fact that the plugin (in this case ‘rpoly’) became available for use as a seamless part of the CADQUERY API itself. This is an important feature of the invention, because it allows extensions of the CADQUERY API to be used with very little effort by designers who are not familiar with the plugin.

It should be noted that there are many types of extensions that can be implemented using this mechanism, and that all of them would be in the spirit of this invention. Other examples may include but are not limited to; additional printing instructions; additional validation routines to help designers avoid problems customizing models; additional types of parameters; processors for loading other kinds of content, such as 2d drawings in DXF format; exporters to allow creation of other types of 3D models; colors and textures to improve the visual appearance of the model; assembly instructions to assist in locating objects relative to others in the script;

The use of a general purpose programming language provides substantial flexibility, but it also introduces substantial risk. In the preferred embodiment, Python is used as an underlying scripting language for model scripts. The use of this language allows scripts to include many language features and libraries that are already available, such as loops, conditionals, math, and utility libraries. This flexibility provides a distinct advantage relative to systems such as OpenSCAD, which uses a proprietary language that is limited in its function.

However, the flexibility presents a security challenge. A general purpose language can intentionally or unintentionally damage or interrupt operation of the computer running the script. The risk is especially high when the plugin framework allows execution of scripts from remote servers. In the most benign cases, the script could consume CPU resources briefly and slow performance, while in extreme cases, the script could contain malicious content and use the host computer to launch malware attacks. The invention solves this challenge through use of a technique called sandboxing.

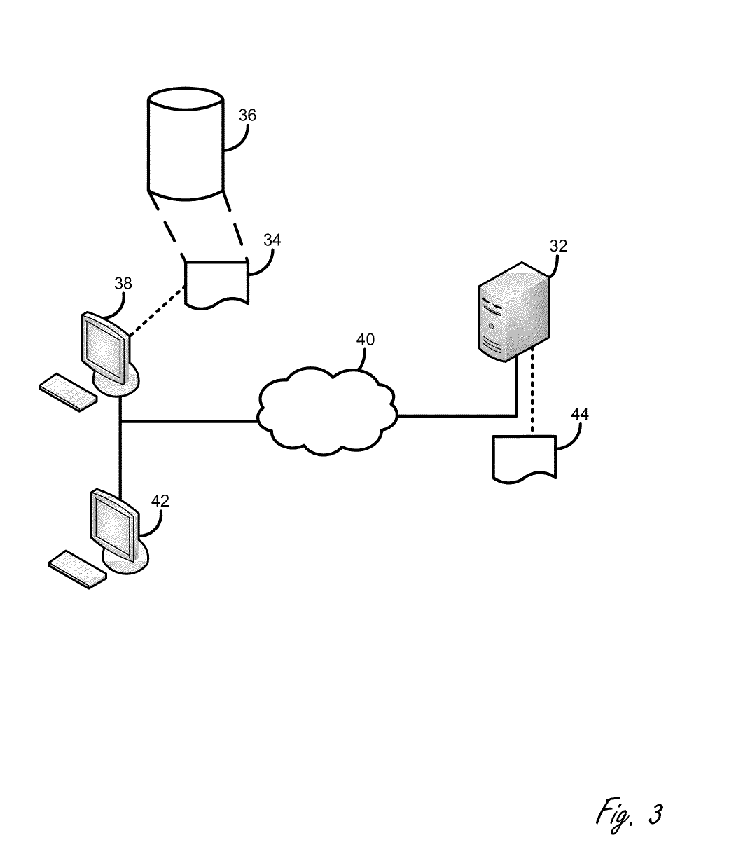

Referring to FIG. 3, the invention is shown with the server 32 having a processor and being in communications with a non-transitory computer readable medium. Computer readable instructions are contained on the computer readable medium allowing the server to receive a 3D model file 34 representing a 3D shape 36 that is generated by a first designer using a first designer computer system 38 using a fluent development language. The first designer computer system is in communications with the server through a local or wide area network 40. The 3D model file can be created using computer readable instructions on the server that are accessed by the first designer computer system such as in a SaaS model or locally on the first designer computer system. The 3D model file, with its metadata (e.g. parameters, title, license, etc.) can be transmitted to the server for storage in a single integrated file. A second designer computer system 42 can access the computer readable medium of the server and view the 3D model file, its text or script and its visual representation as displaced on the second designer computer system. The second designer, according to the dynamic parameters, can modify the 3D model file using a modification interface on the second design computer system. The modification interface can be graphical or textual. Once the 3D model file is modified to the satisfaction of the second designer using the second designer computer system, the second designer can transmit to the server a build request. The server computer readable instructions can then generate a 3D print file 44. The second designer computer system can also send transmission instructions that cause the server to transmit to the 3D print file to a remote location such as the second designer computer system, a third party print bureau or another location.

In one embodiment, the computer readable instructions of the server can receive credit instructions associated with the license that is associated with the 3D model file so that the second computer system will only be allowed to implement certain actions upon the payment of credits from the second designer.

It is understood that the above descriptions and illustrations are intended to be illustrative and not restrictive. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A system for designing, creating and modifying a 3D printing file for use with a 3D printer comprising:
a server having a non-transitory computer readable medium and a processor in electronic communications with said non-transitory computer readable medium;
a set of computer readable instructions stored in said non-transitory computer readable medium that when executed by said processor causes said server to perform the steps of: receiving a 3D model file representing a physical shape from a first designer's computer system in communications with said server generated by a first designer using a fluent development language having a set of basic selection commands and a set of workplane commands, said 3D model having dynamic parameters and static parameters, said workplane commands having 2D commands and 3D commands, receiving modification instructions from a second designer's computer system in communication with said sever representing desired modifications to said 3D model file desired by a second designer using a modification interface to modify the 3D model file wherein only said dynamic parameters can be modified, receiving build instructions from said second designer's computer system instructing said server to generate a 3D print file suitable for a 3D printer from said 3D model file, receiving transmission instructions from said second designer's computer system instructing said server to transmit said 3D print file to a remote computer system from that of said server, and transmitting said 3D print file to said remote computer system in response to receiving said transmission instructions.

2. The system of claim 1 wherein said fluent development language includes command selected from the set of CADQuery commands.

3. The system of claim 1 wherein said set of computer readable instructions include instructions for receiving credit instructions representing credits from said second designer's computer system prior to modifying said 3D model file according to said modification instructions.

4. The system of claim 1 wherein said set of computer readable instructions includes instructions for receiving credit instructions from said second designer's computer system prior to transmitting said 3D model to said remote computer system.

5. The system of claim 1 wherein said remote computer system is said second designer's computer system.

6. The system of claim 1 wherein said remote computer system is a printing service bureau.

7. The system of claim 1 wherein said basic selection commands are selected from a set of CQ commands.

8. The system of claim 1 wherein said workplane commands are selected from a set of WorkPlane commands.

9. The system of claim 1 wherein said modification interface is a graphical user interface displayed on said second designer's computer system.

10. The system of claim 1 wherein said modification interface is a set of computer readable instructions residing on the designer's computer system.

11. A system for storing and modifying a 3D printing file for use in 3D printing comprising:
a server having a non-transitory computer readable medium and a processor in electronic communications with said non-transitory computer readable medium; and,
a set of computer readable instructions stored in said non-transitory computer readable medium that when executed by said processor causes said server to preform the steps of: receiving a 3D model file representing a physical shape from a first designer's computer system in communications with said server generated by a first designed using a 3D fluent development language having a set of basic selection commands and a set of workplane commands, said 3D model having dynamic parameters and static parameters, said workplane commands having 2D commands and 3D commands, receiving a presentation request from a second designer's computer system in communications with said server representing a request from the second designer to display a three dimensional representation of said 3D model file on said second designer's compute system, transmitting display information to said second designer's computer system so that said three dimensional representation of said 3D model file is displayed on said second designer's compute system, receiving build instructions from said second designer's computer system instructing said server to generate a 3D print file suitable for a 3D printer from said 3D model file, receiving transmission instructions from said second designer's computer system instructing said server to transmit said 3D print file to a remote computer system that is remote from said server, and, transmitting said 3D print file to said remote computer system in response to receiving said transmission instructions.

12. The system of claim 11 wherein said basic selection commands are selected from a set of CQ commands.

13. The system of claim 11 wherein said workplane commands are selected from a set of WorkPlane commands.

14. The system of claim 11 wherein said 3D fluent development language includes Selectors.

15. A system for selecting and modifying a 3D printing file for use in 3D printing comprising:
a server having a non-transitory computer readable medium and a processor in electronic communications with said non-transitory computer readable medium;
a set of 3D model files representing physical shapes stored in said non-transitory computer medium having dynamic parameters and static parameters;
a set of computer readable instructions stored in said non-transitory computer readable medium that when executed by said processor causes said server to perform the steps of: receiving selection information from a designer's computer system representing a selection of one 3D model file from said set of 3D model files, transmitting display information to said designer's computer system so that a three dimensional representation of said selected 3D model file is displayed on said designer's computer system, receiving modification instructions from said designer's computer system representing desired modifications to said selected 3D model file desired by a designer using a modification user interface to modify said selected 3D model file wherein only said dynamic parameters can be modified, said modification instructions include a set of basic selection commands and a set of workplane commands, said workplane commands having 2D commands and 3D commands, receiving build instructions from said designer's computer system instructing said server to generate a 3D print file suitable for a 3D printer from said 3D model file, receiving transmission instructions from said designer's computer system instructing said server to transmit said 3D print file to a remote computer system from that of said server, and transmitting said 3D print file to said remote computer system in response to receiving said transmission instructions.

16. The system of claim 15 wherein said modification instructions are instructions selected from a fluent CADQuery development language

17. The system of claim 15 wherein said basic selection commands are selected from a set of CQ commands.

18. The system of claim 15 wherein said workplane commands are selected from a set of WorkPlane commands.

19. The system of claim 15 wherein said remote computer system is said designer's computer system.

20. The system of claim 15 wherein said remote computer system is a printing service bureau.

21. The system of claim 15 wherein said modification instructions include instructions generated from a graphical user interface displayed on said designer's computer system.

22. The system of claim 15 wherein said modification instructions include textual instructions generated from a text editor interface displayed on said designer's computer system.

23. The system of claim 15 wherein said modification instructions and said build instructions are received from said designer's computer system is received as an integrated transmission.

24. The system of claim 15 wherein said modification instructions and 3D model file are received from said designer's computer system as an integrated transmission.
